(19) United States
(12) Patent Application Publication
(10) Pub. No.: US 2010/0098532 A1
(43) Pub. Date: Apr. 22, 2010

(54) COMPRESSOR HOUSING

(75) Inventors: Paul D. Diemer, Arden, NC (US); Edward R. Panek, Anthem, AZ (US); David G. Grabowska, Asheville, NC (US)

Correspondence Address: BORGWARNER INC. C/O PATENT CENTRAL LLC, 1401 HOLLYWOOD BOULEVARD, HOLLYWOOD, FL, 33020-5237, US

(73) Assignee: BORGWARNER INC., Auburn Hills, MI (US)

(21) Appl. No.: 12/525,603

(22) PCT Filed: Feb. 11, 2008
(86) PCT No.: PCT/US08/53554

§ 371 Date: Aug. 3, 2009

Related U.S. Application Data
(60) Provisional application No. 60/889,867, filed on Feb. 14, 2007.

(51) Int. Cl. F04D 29/44; B23P 17/00

(52) U.S. Cl. 415/203; 29/889.22

(57) ABSTRACT

A compressor section (100) of a turbocharger (501) or other air boost device is provided that can reduce stall noise. The compressor section has a housing (110) with a blind groove (175, 275) formed therein. The blind groove (175, 275) can be in proximity to a leading edge (155) of at least one of the blades (150) and can straddle the leading edges (155) of the splitter blades (150). The blind groove (175, 275) can be formed by machining and/or casting. The blind groove (175, 275) can have a substantially uniform width and depth, and can circumscribe the impeller (130) to form a continuous annular channel.

### FIELD OF THE INVENTION

This invention is directed to a turbocharging system for an internal combustion engine and more particularly to a compressor housing.

### BACKGROUND OF THE INVENTION

Turbochargers are widely used on internal combustion engines, and in the past have been particularly used with large diesel engines, especially for highway trucks and marine applications. Compressor impeller wheels are found in both superchargers, which derive their power directly from the crankshaft of the engine, and turbochargers, which are driven by the engine exhaust gases.

More recently, in addition to use in connection with large diesel engines, turbochargers have become popular for use in connection with smaller, passenger car power plants. The use of a turbocharger in passenger car applications permits selection of a power plant that develops the same amount of horsepower from a smaller, lower mass engine. Using a lower mass engine has the desired effect of decreasing the overall weight of the car, increasing sporty performance, and enhancing fuel economy. Moreover, use of a turbocharger permits more complete combustion of the fuel delivered to the engine, thereby reducing the hydrocarbon emissions of the engine, which contributes to the highly desirable goal of a cleaner environment. The design and function of turbochargers are described in detail in the prior art, for example, U.S. Pat. Nos. 4,705,463, 5,399,064, and 6,164,931, the disclosures of which are incorporated herein by reference.

Turbocharger units typically include a turbine operatively connected to the engine exhaust gas manifold, a compressor operatively connected to the engine air intake manifold, and a shaft connecting the turbine and compressor so that rotation of the turbine wheel causes rotation of the compressor impeller. The turbine is driven to rotate by the exhaust gas flowing in the exhaust manifold. The compressor impeller is driven to rotate by the turbine, and as it rotates, it increases the air mass flow rate, airflow density and air pressure delivered to the engine cylinders.

Turbocharger compressors consist of three fundamental components: compressor wheel, diffuser, and housing. The compressors typically work by drawing air in axially, accelerating the air to a high velocity through the rotational speed of the wheel, and expelling the air in a radial direction. The diffuser slows down the high-velocity air, which in exchange increases the pressure and the temperature. The diffuser is formed by the compressor backplate and a part of the volute housing, which in turn collects the air and slows it down before it reaches the compressor exit.

The blades of a compressor wheel can have a highly complex shape, for (a) drawing air in, (b) accelerating it, and (c) discharging air outward at an elevated pressure into the volute-shaped chamber of a compressor housing. In order to accomplish these three distinct functions with maximum efficiency and minimum turbulence, the blades typically have three separate regions.

First, the leading edge of the blade can be described as a sharp pitch helix, adapted for scooping air in and moving air axially. Considering only the leading edge of the blade, the cantilevered or outboard tip travels faster (MPS) than the part closest to the hub, and is generally provided with an even greater pitch angle than the part closest to the hub. Thus, the angle of attack of the leading edge of the blade undergoes a twist from lower pitch near the hub to a higher pitch at the outer tip of the leading edge. Further, the leading edge of the blade generally is bowed, and is not planar. Further yet, the leading edge of the blade generally has a “dip” near the hub and a “rise” or convexity along the outer third of the blade tip. These design features are all designed to enhance the function of drawing air in axially.

Next, in the second region of the blades, the blades are curved in a manner to change the direction of the airflow from axial to radial, and at the same time to rapidly spin the air centrifugally and accelerate the air to a high velocity, so that when diffused in a volute chamber after leaving the impeller, the energy is recovered in the form of increased pressure. Air is directed through airflow channels defined between the blades, as well as between the inner wall of the compressor wheel housing and the radially enlarged disc-like portion of the hub which defines a floor space, the housing-floor spacing narrowing in the direction of air flow.

Finally, in the third region, the blades terminate in a trailing edge, which is designed for propelling air out of the compressor wheel. The design of this blade trailing edge is generally complex, provided with (a) a pitch, (b) an angle offset from radial, and/or (c) a back taper or back sweep (which, together with the forward sweep at the leading edge, provides the blade with an overall “S” shape). Air expelled in this way has not only high flow, but also high pressure.

The operating behavior of a compressor within a turbocharger may be graphically illustrated by a “compressor map” associated with the turbocharger in which the pressure ratio (compression outlet pressure divided by the inlet pressure) is plotted on the vertical axis and the flow is plotted on the horizontal axis. In general, the operating behavior of a compressor wheel is limited on the left side of the compressor map by a “surge line” and on the right side of the compressor map by a “choke line.” The surge line basically represents “stalling” of the airflow at the compressor inlet. As air passes through the air channels between the blades of the compressor impeller, boundary layers build up on the blade surfaces. These low momentum masses of air are considered a blockage and loss generators. When too small a volume flow and too high of an adverse pressure gradient occurs, the boundary layer can no longer adhere to the suction side of the blade. When the boundary layer separates from the blade, stall and reversed flow occurs. Stall can continue until a stable pressure ratio, by positive volumetric flow rate, is established. However, when the pressure builds up again, the cycle will repeat. This flow instability continues at a substantially fixed frequency, and the resulting behavior is known as “surging.” The “choke line” represents the maximum centrifugal compressor volumetric flow rate as a function of the pressure ratio, which is limited for instance by the minimal cross-section of the channel between the blades, called the throat. When the flow rate at the compressor inlet or other throat location reaches sonic velocity, no further flow rate increase is possible and choking results. Both surge and choking of a compressor should be avoided.

An attempt to address the problem of impeller stall can be found in U.S. Pat. No. 4,743,161 to Fisher et al. As shown in FIG. 1, Fisher et al. shows a recirculation passage 36 in a turbocharger compressor housing 10 having an impeller wheel 12 mounted on shaft 13. The wheel 12 includes a plurality of blades or vanes 14, each including a leading edge 16, a trailing edge 18 and an outer free edge 20. The housing 10 includes an outer wall 22, defining an intake 24 for gas such as air, and a passageway or volute 26 for carrying compressed gas from an annular diffuser 27. An inner wall 28 defines an inlet 30 to the impeller and an inner surface 32 of the inner wall 28 is in close proximity to, and of extremely similar contour to, the outer free edges 20 of the blades or vanes 14. The inner wall 28 extends a short distance upstream from the blades 14 of the impeller wheel 12 to form an annular space or chamber 34 between the walls 22 and 28. The annular chamber 34 partly surrounds the impeller wheel 12. The annular slot 36 is formed in the wall 28 and a series of webs 38 serve to bridge the annular slot 36 at intervals round its circumference. The slot 36 is located 73% of the distance from the leading edge 16 of the blades 14 to the point of minimum pressure and is 30% of the length of the impeller blades 14 from the leading edges 16 of the blades.

The Fisher recirculation passage 36 is intended to produce a positive differential pressure on the inlet at choke and a negative differential pressure on the inlet at surge. While the recirculation passage 36 helps to reduce the pressure differential, it creates the problem of increasing the amount of noise emitted. Further, in recirculation, the same air is passed through the compressor passage twice, increasing the workload on the compressor.

Thus, there is a need for a compressor housing that reduces stall noise while maintaining efficiency. There is a further need for such a housing that is cost efficient, fuel-efficient and inexpensive to manufacture.

### SUMMARY OF THE INVENTION

The exemplary embodiments of the housing, and the turbocharger or other air boost device that uses the housing, reduce stall noise. The housing can provide a flow path around rotating stall in the compressor section which results in a reduction or elimination of noise during compressor stall.

In one aspect, a compressor housing for an air boost device having an impeller with blades is provided. The compressor housing comprises a body having an inner surface and defining a diffuser and an impeller chamber. The impeller is mounted at least partially in the impeller chamber. The inner surface has a blind groove circumscribing the impeller to form a continuous annular channel. The blind groove is upstream of the diffuser.

In another aspect, a turbocharger is provided comprising: a turbine housing having a turbine rotor; a compressor housing having an inner surface and defining an impeller chamber; and a compressor impeller mounted in the compressor housing and having a plurality of blades. The compressor impeller is operably connected to the turbine rotor for driving the compressor impeller. The inner surface of the compressor housing has a blind groove in proximity to the plurality of blades of the compressor impeller.

In another aspect, a method of reducing stall noise in a turbocharger is provided. The method comprises forming a blind groove along an inner surface of a housing in proximity to blades of an impeller to provide a path for fluid around a rotating stall.

### BRIEF DESCRIPTION OF THE DRAWINGS

The present invention is illustrated by way of example and not limitation in the accompanying drawings in which like reference numbers indicate similar parts, and in which:

FIG. 1 is a schematic representation of a compressor section of a contemporary turbocharger system;

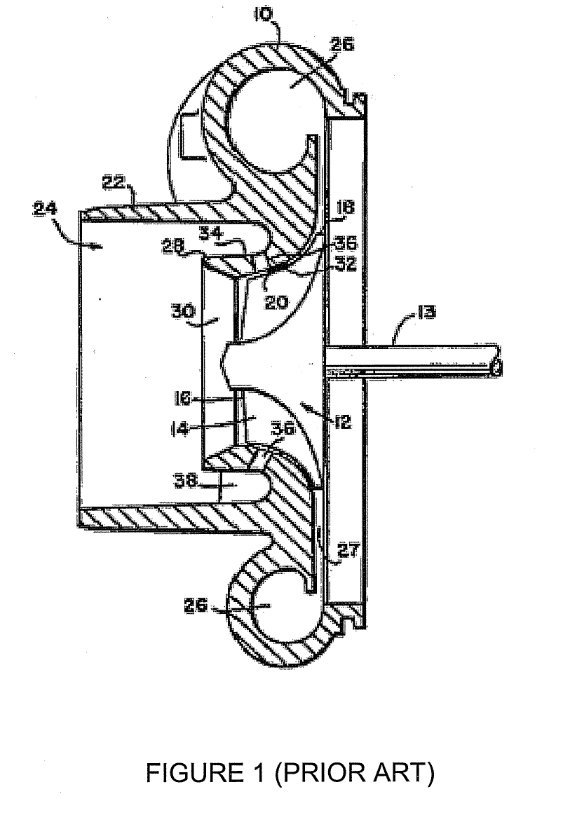

FIG. 2 is a cross-sectional view of an exemplary embodiment of a compressor section of an air boost device in accordance with the present invention;

FIG. 3 is an enlarged view of a portion of the compressor section of FIG. 2 showing only a portion of the impeller;

FIG. 4 is an enlarged view of another exemplary embodiment of a compressor section of an air boost device in accordance with the present invention showing only a portion of the impeller; and

FIG. 5 is a cross-sectional perspective view of a turbocharger using a blind groove in the compressor housing in accordance with an exemplary embodiment of the present invention.

### DETAILED DESCRIPTION OF THE INVENTION

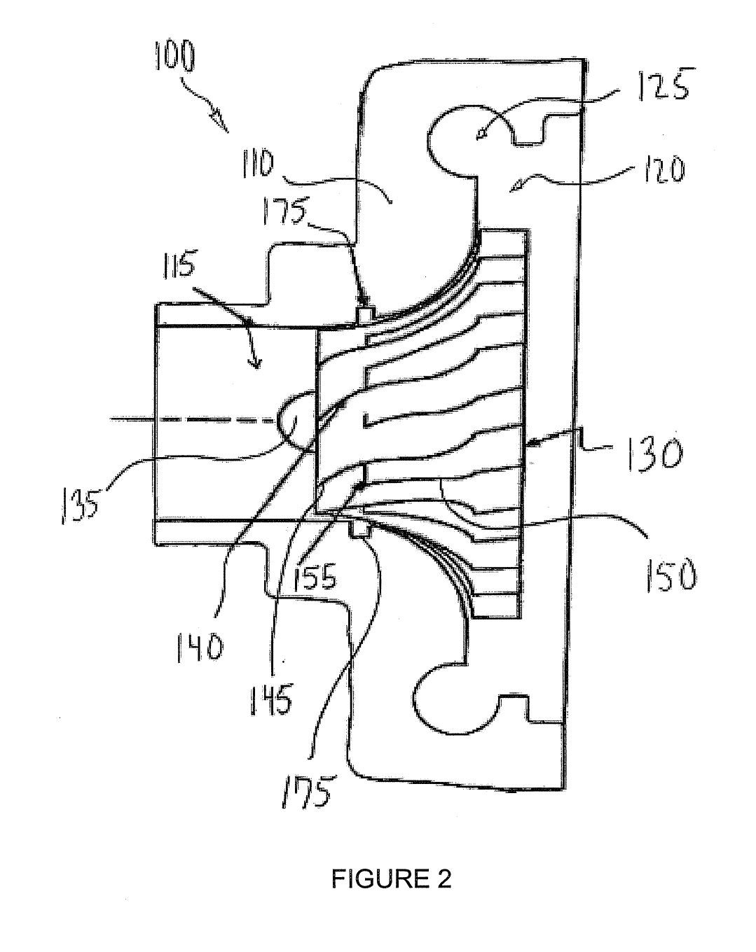

Embodiments of the invention are directed to reducing or eliminating stall noise in an air boost device. Aspects of the invention will be explained in connection with a compressor section having various components including a diffuser and scroll, but the detailed description is intended only as exemplary. Exemplary embodiments of the invention are shown in FIGS. 2-5, but the present invention is not limited to the illustrated structure or application.

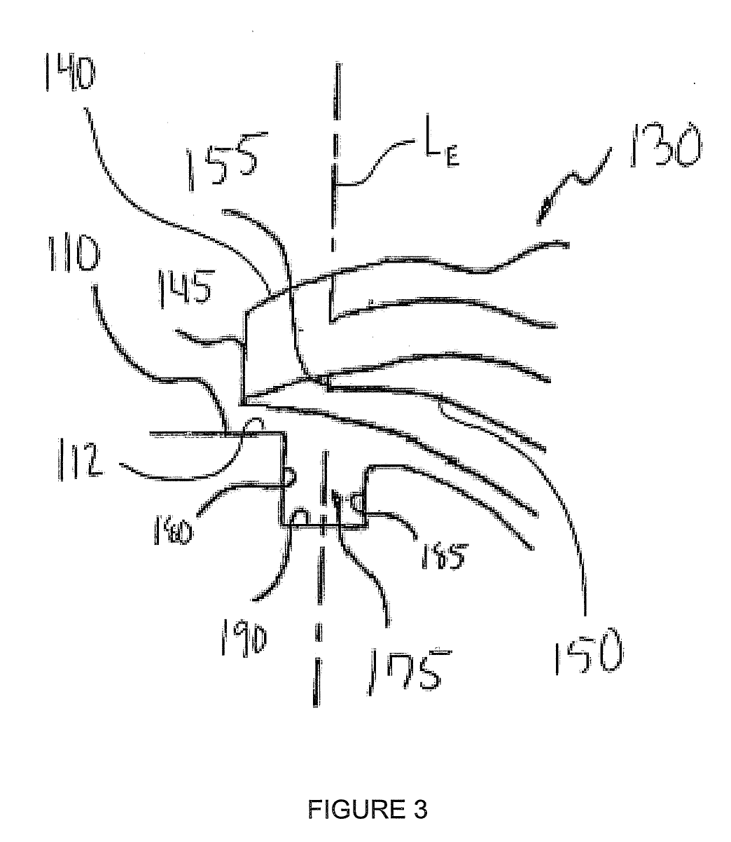

Referring to FIGS. 2-3, a compressor section for a turbocharger or other air boost device is shown and generally represented by reference numeral 100. The compressor section 100 has a housing or body 110 defining an impeller chamber 115, a diffuser 120 and a scroll 125. The compressor section 100 rotatably houses a compressor impeller 130 that compresses fluid, directs the fluid through the diffuser 120 and scroll 125, and delivers the compressed fluid to its destination, such as an internal combustion engine. The impeller 130 can have a plurality of blades, for example full blades 140 with leading edges 145 and splitter blades 150 with leading edges 155 that are alternatingly arranged and connected to a hub 135. The present disclosure contemplates the use of various compressor impellers with the compressor section 100, which can have various sizes, shapes and blade configurations, as well as being made from various materials, including aluminum, titanium and alloys thereof. The particular size, shape, blade configuration and material of compressor impeller 130 can be chosen by one of ordinary skill in the art based upon a number of factors, including the air boost performance desired.

Housing 110 has a blind groove or channel 175 formed along an inner surface 112 of the housing. Preferably, the groove 175 is in proximity to the leading edges 155 of the splitter blades 150 and forms a continuous annular path circumscribing the impeller 130. The groove 175 preferably lies in a plane that is perpendicular to the axis of rotation of the impeller 130. However, the present disclosure contemplates the use of a discontinuous path for groove 175, as well as other shapes, directions and planes, for the groove.

The particular shape, direction, plane and continuity for the groove 175 can be chosen based upon a number of factors, including the size, shape and blade configuration of the impeller 130. In one embodiment, as shown more clearly in FIG. 3, the groove 175 is positioned along the inner surface 112 of the housing 110 so as to straddle the leading edges 155 of the splitter blades 150 as shown by line L_{E}. The exemplary embodiment of FIGS. 2-3 has a one-piece housing 110 of a particular size and shape. However, it should be understood that the present disclosure also contemplates the use of compressor housings of other sizes and shapes, as well as being assembled from two or more housing portions. The housing 110 can be made from various materials and combinations of materials, such as aluminum, and can include various treatments and coatings.

The groove 175 preferably circumscribes the inner surface 112 of the housing 110 to form a continuous annular groove or channel. The groove 175 can have opposing side walls 180 and 185, and a base 190 to define a volume therethrough. The groove 175 preferably has a width in the axial direction of between 1 to 4 mm, and more preferably between 1.75 to 2.75 mm. The depth of the groove 175 in the radial direction can be between 1 to 4 mm and more preferably between 1.75 to 2.75 mm. However, other dimensions for the grooves 175 are contemplated by the present disclosure, which can be chosen based upon a number of factors, including the size and pressure ratio of the turbocharger or other air boost device. For example, a radial depth for the groove 175 greater than 2.75 mm can be chosen but larger dimensions may be constrained by the thickness of the compressor housing walls. The groove 175 preferably has a uniform width and depth. Although the present disclosure contemplates using a non-uniform width and/or depth of the groove 175.

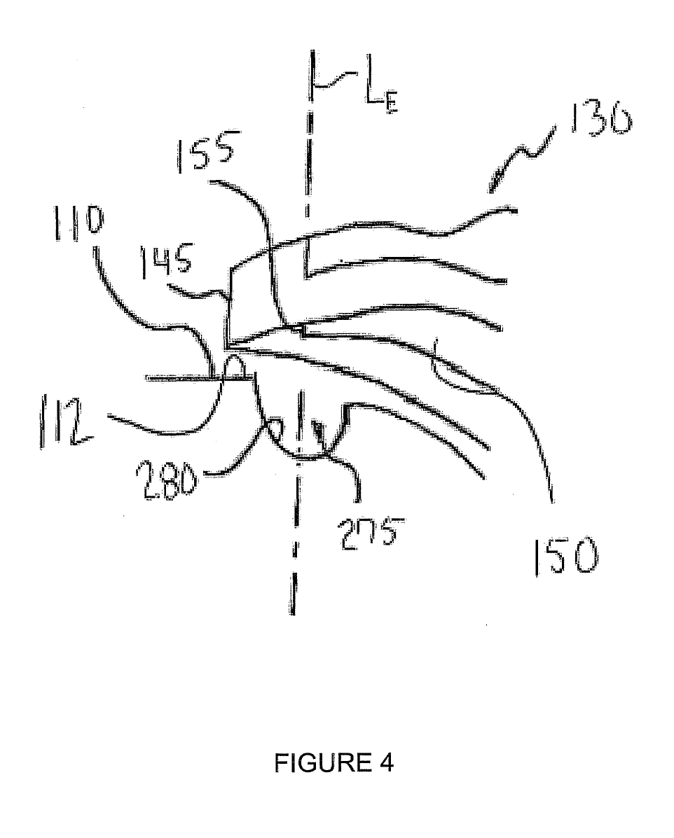

The groove 175 can be machined into the inner surface 112, can be cast into the housing 110, and can be formed by a combination of casting and machining. While the exemplary embodiment of FIGS. 2-3 has a substantially square or U-shaped groove 175 in a cross-sectional view, the present disclosure contemplates other shapes being used to form the groove. For example, as shown in FIG. 4, a curved or substantially hemi-spherical groove 275 can be formed along the inner surface 112 of the housing 110 to reduce compressor stall noise. The curved groove 275 is preferably in proximity to the leading edges 155 of the splitter blades 150 and more preferably straddles the leading edges as shown by line L_{E}. The shape of the curved groove 275 can be symmetrical or non-symmetrical, and can be formed by casting, machining or a combination of casting and machining. Other shapes in a cross-sectional view for the grooves 175 and 275 are also contemplated by the present disclosure.

The use of groove 175 along the inner surface 112 of compressor housing 110 reduced compressor stall noise during testing. These results are explained in detail in example 1.

### EXAMPLE 1

A contemporary compressor section having a 67 mm diameter impeller and a housing with a substantially smooth inner surface in proximity to the leading edges of the splitter blades of the impeller, was used for comparison with the compressor section 100 of the exemplary embodiment of FIGS. 2-3. The impeller of the contemporary compressor section was rotated at about 75% of maximum speed to induce stall. The stall noise was measured at about 48-50 dba.

The compressor impeller 130 having a diameter of 67 mm was mounted within the housing 110 of the exemplary embodiment of FIGS. 2-3. The housing 110 had a continuous groove 175 with a width in the axial direction of 2 mm and a depth in the radial direction of 2 mm. The groove 175 was along the inner surface 112 of the housing 110 so as to straddle the leading edges 155 of the splitter blades 150. The impeller 130 was rotated at about 75% of maximum speed to induce stall. The stall noise for the exemplary embodiment of compressor section 100 was measured at about 38 dba. The use of groove 175 significantly reduced noise during compressor stall.

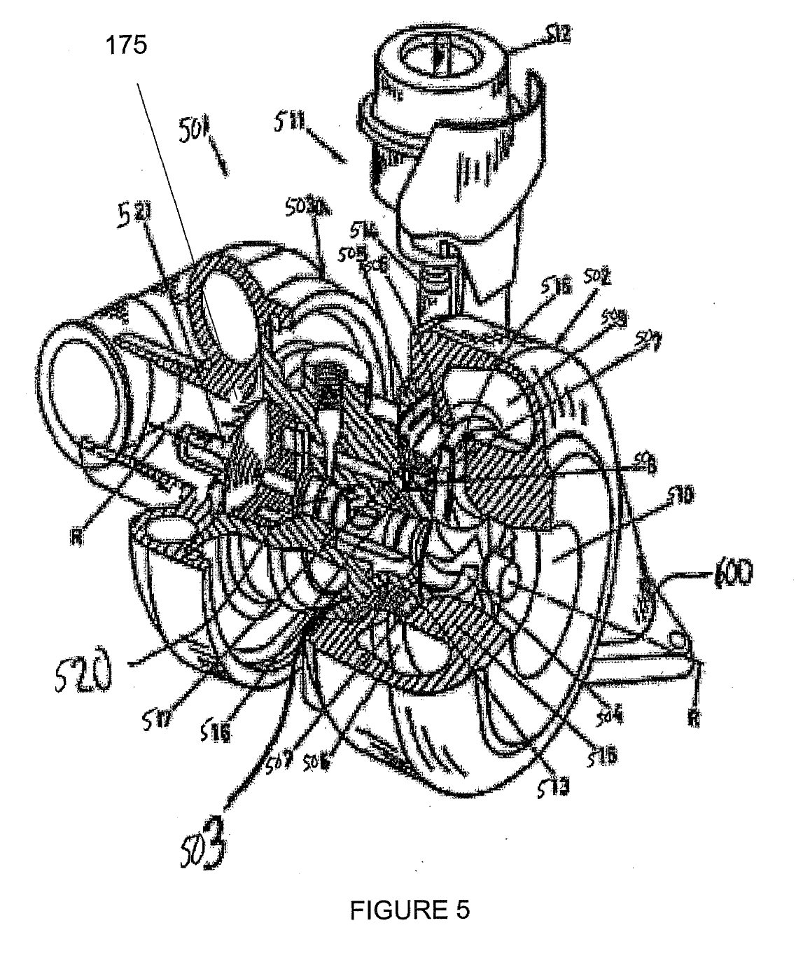

Referring to FIG. 5, a turbocharger 501 has a turbine housing 502, a center housing 503 and a compressor housing 503a connected to each other and positioned along an axis of rotation R. The turbine housing 502 has an outer guiding grid of guide vanes 507 over the circumference of a support ring 506. The guide vanes 507 may be pivoted by pivoting shafts 508 inserted into bores of the support ring 506 so that each pair of vanes define nozzles of selectively variable cross-section according to the pivoting position of the vanes 507. This allows for a larger or smaller amount of exhaust gases to be supplied to a turbine rotor 504.

The exhaust gases are provided to the guide vanes 507 and rotor 504 by a supply channel 509 having an inlet 600. The exhaust gases are discharged through a central short feed pipe 510, and the rotor 504 drives the compressor wheel, impeller or rotor 521 fastened to the shaft 520 of the wheel. The present disclosure also contemplates one or more of turbine housing 502, center housing 503 and compressor housing 503a being integrally formed with each other.

In order to control the position of the guide vanes 507, an actuation device 511 can be provided having a control housing 512, which controls an actuation movement of a pestle member 514 housed therein, whose axial movement is converted into a rotational movement of an adjustment or control ring 505 situated behind the support ring 506. By this rotational movement, the guide vanes 507 may be displaced from a substantially tangential extreme position into a substantially radially extending extreme position. In this way, a larger or smaller amount of exhaust gases from a combustion motor supplied by the supply channel 509 can be fed to the turbine rotor 504, and discharged through the axial feed pipe 510.

Between the vane support ring 506 and a ring-shaped portion 515 of the turbine housing 502, there can be a relatively small space 513 to permit free movement of the vanes 507. The shape and dimensions of the vane space 513 can be chosen to increase the efficiency of the turbocharger 501, while allowing for thermal expansion due to the hot exhaust gases. To ensure the width of the vane space 513 and the distance of the vane support ring 506 from the opposite housing ring 515, the vane support ring 506 can have spacers 516 formed thereon. Various other turbocharger components can also be used with compressor wheel 521 and turbocharger 501. The groove 175 is formed along the inner surface of the compressor housing 503a to reduce or eliminate compressor stall noise.

Although a compressor impeller or wheel has been described herein with great detail with respect to an embodiment suitable for the automobile or truck industry, it will be readily apparent that the compressor wheel and the process for production thereof are suitable for use in a number of other applications, such as fuel cell powered vehicles and in other air boost devices. The features of the exemplary embodiment can be applied to the housings of other impellers that are subjected to stall. Although this invention has been described in its preferred form with a certain of particularity with respect to an automotive internal combustion compressor impeller, it is understood that the present disclosure of the preferred form has been made only by way of example and that numerous changes in the details of structures and the composition of the combination may be resorted to without departing from the spirit and scope of the invention.

We claim:

1. A compressor housing (110) for an air boost device having an impeller (130) with blades (150), the compressor housing (110) comprising:
a body having an inner surface (112) and defining a diffuser (120) and an impeller chamber (115), wherein the impeller (130) is mounted at least partially in the impeller chamber (115), wherein the inner surface (112) has a blind groove (175, 275) circumscribing the impeller (130) to form a continuous annular channel, and wherein the blind groove (175, 275) is upstream of the diffuser (120).

2. The compressor housing (110) of claim 1, wherein the blind groove (175, 275) is in proximity to a leading edge (155) of at least one of the blades (150) of the impeller (130).

3. The compressor housing (110) of claim 1, wherein the blind groove (175, 275) is positioned along the inner surface (112) to straddle a leading edge (155) of at least one of the blades (150) of the impeller (130).

4. The compressor housing (110) of claim 1, wherein the blind groove (175, 275) has a width in an axial direction of between 1 to 4 mm.

5. The compressor housing (110) of claim 1, wherein the blind groove (175, 275) has a depth in a radial direction of between 1 to 4 mm.

6. The compressor housing (110) of claim 1, wherein the blind groove (175, 275) has a width in an axial direction of between 1 to 4 mm, a depth in a radial direction of between 1 to 4 mm, and wherein the width and depth are substantially uniform along the continuous annular channel.

7. A turbocharger (501) comprising:
a turbine housing (502) having a turbine rotor (504);
a compressor housing (110) having an inner surface (112) and defining an impeller chamber (115); and
a compressor impeller (130) mounted in the compressor housing (110) and having a plurality of blades (150), the compressor impeller (130) being operably connected to the turbine rotor (504) for driving the compressor impeller (130),
wherein the inner surface (112) of the compressor housing (110) has a blind groove (175, 275) in proximity to the plurality of blades (150) of the compressor impeller (130).

8. The turbocharger (501) of claim 7, wherein the blind groove (175, 275) is in proximity to a leading edge (155) of at least one of the plurality of blades (150).

9. The turbocharger (501) of claim 7, wherein the plurality of blades (150) comprises a plurality of full blades (140) and a plurality of splitter blades (150), and wherein the blind groove (175, 275) is in proximity to leading edges (155) of the plurality of splitter blades (150).

10. The turbocharger (501) of claim 9, wherein the blind groove (175, 275) straddles the leading edges (155) of the plurality of splitter blades (150).

11. The turbocharger (501) of claim 7, wherein the compressor housing (110) defines at least in part a diffuser (120), wherein the blind groove (175, 275) is upstream of the diffuser (120), and wherein the blind groove (175, 275) is downstream of a leading edge (145) of the compressor impeller (130).

12. The turbocharger (501) of claim 7, wherein the blind groove (175, 275) has a width in an axial direction of between 1 to 4 mm.

13. The turbocharger (501) of claim 7, wherein the blind groove (175, 275) has a depth in a radial direction of between 1 to 4 mm.

14. The turbocharger (501) of claim 7, wherein the blind groove (175, 275) circumscribes the compressor impeller (130) to form a continuous annular channel along the inner surface (112) of the compressor housing (110).

15. The turbocharger (501) of claim 14, wherein the blind groove (175, 275) has a width in an axial direction of between 1 to 4 mm, a depth in a radial direction of between 1 to 4 mm, and wherein the width and depth are substantially uniform along the continuous annular channel.

16. A method of reducing stall noise in a turbocharger (501), the method comprising:
forming a blind groove (175, 275) along an inner surface (112) of a housing (110) in proximity to blades (150) of an impeller (130) to provide a path for fluid around a rotating stall.

17. The method of claim 16, further comprising forming the blind groove (175, 275) in proximity to a leading edge (155) of a splitter blade (150) of the impeller (130).

18. The method of claim 16, further comprising forming the blind groove (175, 275) as a continuous annular channel circumscribing the impeller (130).

19. The method of claim 17, further comprising forming the blind groove (175, 275) with a width in an axial direction of between 1 to 4 mm and a depth in a radial direction of between 1 to 4 mm.

20. The method of claim 17, further comprising forming the blind groove (175, 275) with a width in an axial direction of between 1.75 to 2.75 mm and a depth in a radial direction of between 1.75 to 2.75 mm.
